(19) United States
(12) Patent Application Publication
(10) Pub. No.: US 2024/0308488 A1
(43) Pub. Date: Sep. 19, 2024

(54) HYDRAULIC PRESSURE SUPPLY DEVICE AND ELECTRONIC BRAKE SYSTEM INCLUDING THE SAME

(71) Applicant: HL MANDO CORPORATION, Gyeonggi-do (KR)

(72) Inventor: Dongjin YUN, Gyeonggi-do (KR)

(21) Appl. No.: 18/603,543

(22) Filed: Mar. 13, 2024

(30) Foreign Application Priority Data
Mar. 14, 2023 (KR) 10-2023-0033562

(51) Int. Cl. B60T 13/14; B60T 8/40; B60T 13/74; B60T 17/02; B60T 17/22

(52) U.S. Cl. CPC B60T 13/148; B60T 8/4081; B60T 13/142; B60T 13/745; B60T 17/02; B60T 17/22; B60T 2220/04

(57) ABSTRACT

The present disclosure relates to a hydraulic pressure supply device and an electronic brake system including the same. The hydraulic pressure supply device comprises: a hydraulic block having therein a flow path through which oil supplied from a reservoir flows; a motor unit that generates rotational driving force by an electrical signal; a piston unit coupled to the hydraulic block and moving forward and backward by the rotational driving force; a pump housing unit which is coupled to the hydraulic block to be opposite to the piston unit and in which oil introduced from the hydraulic block is stored so that the piston unit moving forward and backward forms hydraulic pressure; and a motor position sensor unit that senses rotation of the motor unit, one side and the other side of the motor position sensor unit being respectively coupled to the pump housing unit and the piston unit.

### TECHNICAL FIELD

The present disclosure relates to a hydraulic pressure supply device and an electronic brake system including the same, and more particularly, to a hydraulic pressure supply device which generates and supplies hydraulic pressure using a fluid and an electronic brake system including the same.

### BACKGROUND

A conventional brake system mainly uses a method of supplying hydraulic pressure required for braking to a wheel cylinder using a mechanically connected booster a brake pedal when a driver steps on the brake pedal.

However, as a demand for market to implement various braking functions by precisely responding to operating environments of a vehicle increases, in recent years, an electronic brake system, which when the driver steps on a brake pedal, receives a braking intention of as an electrical signal from a pedal displacement sensor that detects a displacement of the brake pedal and based thereon, and operates a hydraulic pressure supply device to supply hydraulic pressure required for braking to a wheel cylinder, have been widely used.

In the electronic brake system, in a normal operation mode, an brake pedal operation by the driver or determination on braking during a vehicle's autonomous driving is generated and provided, and based on this, the hydraulic pressure supply device is electrically operated and controlled to form the hydraulic pressure required for braking and transfer it to the wheel cylinder. Although such an electronic brake system and operating method can implement complex and diverse braking actions by being electrically operated and controlled, the hydraulic pressure required for braking is not stably formed when a technical problem occurs in an electric component element, which may threaten the safety of passengers.

### SUMMARY

In view of the above, the present disclosure provides a hydraulic pressure supply device including an improved simple and compact structure of a pump housing unit which is coupled to a hydraulic block and forms a flow path for fluid supplied to generate hydraulic pressure, and an electronic brake system including the same.

A hydraulic pressure supply device in accordance with one embodiment of the present disclosure, comprises: a hydraulic block having therein a flow path through which oil supplied from a reservoir flows; a motor unit that generates rotational driving force by an electrical signal; a piston unit coupled to the hydraulic block and moving forward and backward by the rotational driving force; a pump housing unit which is coupled to the hydraulic block to be opposite to the piston unit and in which oil introduced from the hydraulic block is stored so that the piston unit moving forward and backward forms hydraulic pressure; and a motor position sensor unit that senses rotation of the motor unit, one side and the other side of the motor position sensor unit being respectively coupled to the pump housing unit and the piston unit, wherein the pump housing unit includes: a housing body having an open side and an inner space formed therein; and a sleeve inserted into the inner space.

Further, the housing body includes: a first wall; a first side wall extending in a direction intersecting the first wall, a side thereof opposite to the first wall being opened; and a partition wall spaced apart from the first side wall by a set distance in a radial direction and extending parallel to the first side wall at an inner side of the first side wall to form a hollow therein.

In addition, the housing body includes a slot depressed by a set depth in an inner surface of the first side wall and formed to extend from the open side toward the first wall.

Furthermore, the slot includes a plurality of slots spaced apart by a set angle along a circumferential direction of the first side wall.

Moreover, the housing body has a sleeve contact protrusion that is formed on an inner surface of the first wall to be in close contact with any one side of the sleeve inserted into the housing body.

Further, one or more sleeve contact protrusions are formed between the neighboring slots.

In addition, the partition wall is formed so that one end thereof protrudes beyond the open side of the housing body

Furthermore, the housing body further includes a first support protrusion protruding from an outer surface of the first side wall and extending along a circumferential direction thereof.

Further, the sleeve has a sleeve hollow formed to extend along a longitudinal direction thereof, and when the sleeve is inserted into the housing body, one end of the sleeve that is not inserted into the housing body protrudes beyond the open side of the housing body.

In addition, when the sleeve is inserted into the housing body, the other end of the sleeve that is inserted into the housing body comes in close contact with the sleeve contact protrusion so as to maintain perpendicularity between the sleeve and the first wall.

Further, when the sleeve is inserted into the housing body, the slot is formed as an inflow passage through which the oil flows, and a space formed between an inner circumferential surface of the sleeve and an outer circumferential surface of the partition wall becomes an oil storage space for storing the oil so that the piston unit moving forward and backward generates hydraulic pressure.

Furthermore, the pump housing unit further includes a housing fixing member through which the housing body passes and which is fastened to the hydraulic block to fix the housing body.

In addition, the housing fixing member includes a fixed body having a through-hole formed along a longitudinal direction thereof so that the housing body passes therethrough.

Further, the piston unit includes: a ball screw member that converts the rotational driving force into a linear driving force; and a piston body having one side inserted into the pump housing unit, the piston body being coupled to the ball screw member to move forward and backward.

An electronic brake system in accordance with another embodiment of the present disclosure, comprises: a reservoir in which oil is stored; a master cylinder that provides a pedal feeling to a driver while discharging oil by operation of a brake pedal; and a hydraulic pressure supply device that generates hydraulic pressure by operating a hydraulic piston by an electrical signal output in response to displacement of the brake pedal, wherein the hydraulic pressure supply device includes: a hydraulic block having therein a flow path through which oil supplied from the reservoir flows; a motor unit that generates rotational driving force by an electrical signal; a piston unit coupled to one side of the hydraulic block and moving forward and backward by the rotational driving force; a pump housing unit which is coupled to the hydraulic block to be opposite to the piston unit and in which oil introduced from the hydraulic block is stored so that the piston unit moving forward and backward forms hydraulic pressure; and wherein the pump housing unit includes: a housing body having an open side and an inner space formed therein; and a sleeve inserted into the inner space.

Further, the housing body includes: a first wall; a first side wall extending in a direction intersecting the first wall, a side thereof opposite to the first wall being opened; and a partition wall spaced apart from the first side wall by a set distance in a radial direction and extending parallel to the first side wall at an inner side of the first side wall to form a hollow therein.

In addition, the housing body includes a slot depressed by a set depth in an inner surface of the first side wall and formed to extend from the open side toward the first wall.

Furthermore, the housing body has a sleeve contact protrusion that is formed on an inner surface of the first wall to be in close contact with any one side of the sleeve inserted into the housing body.

Further, the sleeve includes a cylindrical second side wall in which a sleeve hollow extending along a longitudinal direction thereof is formed.

In addition, when the sleeve is inserted into the housing body, one end of the sleeve that is inserted into the housing body comes in close contact with the sleeve contact protrusion so as to maintain perpendicularity between the sleeve and the first wall.

The hydraulic pressure supply device and the electronic brake system including the same according to the present disclosure have the following effects.

First, the configuration of the pump housing unit for receiving and storing fluid is formed of the housing body and the sleeve, so that the structure of the pump housing is simplified and assemblability can be improved by simply inserting the sleeve into the housing body.

Second, the housing body includes a hollow partition wall therein and the motor position sensor unit is provided on the partition wall, so that the size of the hydraulic pressure supply device can be reduced.

Third, since the slot is formed inside the housing body, the flow path and the storage space are formed only by inserting the sleeve into the housing body, and the shape of each component is simple, so manufacturing convenience can be improved.

### BRIEF DESCRIPTION OF THE DRAWINGS

FIG. 1 is a block diagram showing the configuration of an electronic brake system according to one embodiment of the present disclosure.

FIGS. 2A and 2B are cross-sectional views showing the structure of a hydraulic pressure supply device according to one embodiment of the present disclosure.

FIG. 3 is an enlarged cross-sectional view of a portion of FIGS. 2A and 2B.

FIG. 4 is a partially exploded perspective view of a part of the hydraulic pressure supply device shown in FIGS. 2A and 2B.

FIG. 5 is a partially exploded perspective view of a pump housing unit of the hydraulic pressure supply device shown in FIGS. 2A and 2B.

FIG. 6 is a cross-sectional view showing the internal structure of a housing body of the pump housing unit shown in FIG. 5.

FIG. 7 illustrates a flow of oil in the pump housing unit according to one embodiment of the present disclosure.

### DETAILED DESCRIPTION

Hereinafter, embodiments of the present disclosure will be described in detail with reference to the accompanying drawings so that those skilled in the art to which the present disclosure pertains can easily carry out the present disclosure. The present disclosure may be implemented in many different forms and is not limited to the embodiments set forth herein.

It is advised that the drawings are schematic and not drawn to scale. Relative dimensions and proportions of parts in the drawings are shown exaggerated or reduced in size for clarity and convenience in the drawings, and any dimensions are illustrative only and not limiting. In addition, like reference numerals are used to designate similar features in the same structural elements or parts appearing in two or more drawings.

The embodiments of the present disclosure specifically represent ideal embodiments of the present disclosure. As a result, various variations of the diagram are expected. Accordingly, the embodiments are not limited to the illustrated specific shapes, and include, for example, modifications of the shapes by manufacturing.

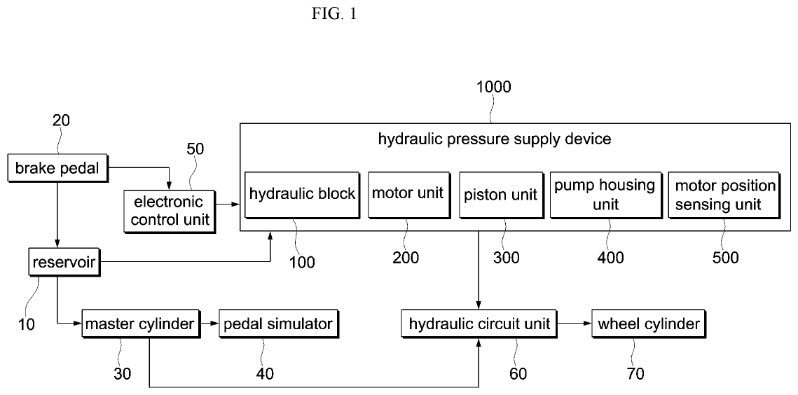

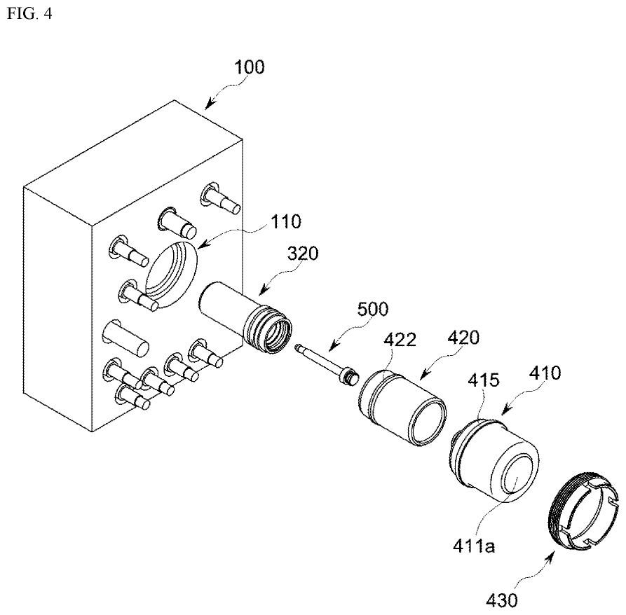

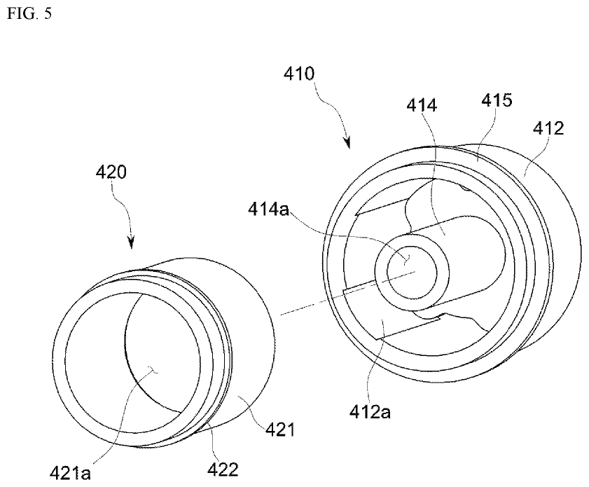

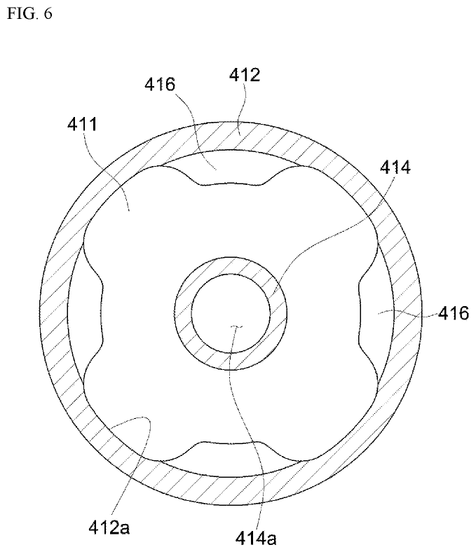

Hereinafter, with reference to FIGS. 1 to 7, an electronic brake system according to the present disclosure and a hydraulic pressure supply device provided thereto will be described in detail.

An electronic brake system according to one embodiment of the present disclosure includes a reservoir 10, a brake pedal 20, a master cylinder 30, a pedal simulator 40, a hydraulic circuit unit 60, an electronic control unit 50, a hydraulic pressure supply device 1000, and a wheel cylinder 70.

The reservoir 10 stores oil, which is a working fluid.

The master cylinder 30 receives oil from the reservoir 10. The master cylinder 30 generates hydraulic pressure to be supplied to the hydraulic circuit unit 60 with supplied oil. Specifically, when the brake pedal 20 is operated by a driver, the master cylinder 30 is pressurized to generate hydraulic pressure.

The hydraulic pressure generated in the master cylinder 30 is transmitted to the pedal simulator 40. The pedal simulator 40 provides a reaction force to the pedal force of the brake pedal 20 to the driver through the hydraulic pressure generated in the master cylinder 30. Through this, the driver can promote detailed operation of the brake pedal 20, and the braking force of the vehicle can be finely adjusted.

Meanwhile, in an emergency situation such as when power is not supplied to the entire system, the hydraulic pressure of the master cylinder 30 may be directly transmitted to the wheel cylinders 70 to brake the vehicle.

The electronic control unit 50 receives an electrical signal according to a displacement detected by the brake pedal 20. The electronic control unit 50 outputs a signal so that the hydraulic pressure supply device 1000 can be operated according to the transmitted electric signal.

When a signal is output from the electronic control unit 50, the hydraulic pressure supply device 1000 generates hydraulic pressure with oil supplied from the reservoir 10 and supplies it to the hydraulic circuit unit 60. The hydraulic circuit unit 60 transmits the hydraulic pressure to the wheel cylinder 70, and when the hydraulic pressure is supplied to the wheel cylinder 70, braking is started.

The hydraulic pressure supply device 1000 includes a hydraulic block 100, a motor unit 200, a piston unit 300, a pump housing unit 400, and a motor position sensing unit 500.

The hydraulic block 100 has a flow path 101 formed therein so that the oil supplied from the reservoir 10 flows therethrough. The hydraulic block 100 is provided with the piston unit 300 and the pump housing unit 400 inserted therein.

The pump housing unit 400 is inserted into the hydraulic block 100 from one side of the hydraulic block 100 and coupled thereto. The piston unit 300 is inserted into the hydraulic block 100 from the other side of the hydraulic block 100 and coupled thereto.

The hydraulic block 100 is formed with a coupling hole 110 extending from one side to the other side so that the piston unit 300 and the pump housing unit 400 can be inserted therein.

The coupling hole 110 includes a first coupling hole portion 111, a second coupling hole portion 112, a third coupling hole portion 113, and a fourth coupling hole portion 114.

The first coupling hole portion 111 is formed to extend from one side of the hydraulic block 100 toward the other side by a set depth. The first coupling hole portion 111 is a portion to which a housing fixing member 430 of the pump housing unit 400 is coupled when the pump housing unit 400 is inserted into the hydraulic block 100. This will be described in more detail later.

The second coupling hole portion 112 is formed to extend from the first coupling hole portion 111 toward the other side by a set depth. The cross-sectional size of the second coupling hole portion 112 is smaller than the cross-sectional size of the first coupling hole portion 111. Accordingly, a stepped portion is formed at the boundary where the first coupling hole portion 111 and the second coupling hole portion 112 are connected. The second coupling hole portion 112 is a portion to which a housing body 410 of the pump housing unit 400 is coupled. This will be described in more detail later.

The third coupling hole portion 113 is formed to extend from the second coupling hole portion 112 toward the other side by a set depth. The cross-sectional size of the third coupling hole portion 113 is smaller than the cross-sectional size of the second coupling hole portion 112. Accordingly, a stepped portion is formed at the boundary where the second coupling hole portion 112 and the third coupling hole portion 113 are connected.

The third coupling hole portion 113 is a portion into which a sleeve 420 of the pump housing unit 400 is inserted and coupled. This will be described in more detail later.

Meanwhile, a side surface of the third coupling hole portion 113 is formed with a sealing member groove 113a which is depressed in a radial direction while extending along a circumferential direction. A sealing member s provided in the sealing member groove 113a seals between the sleeve 420 and the third coupling hole portion 113. As will be described in more detail later, oil is supplied to the inside of the pump housing unit 400, and the sealing member s prevents oil from leaking between the sleeve 420 and the third coupling hole portion 113.

The fourth coupling hole portion 114 is formed to extend from the third coupling hole portion 113 toward the other side. The cross-sectional size of the fourth coupling hole portion 114 is smaller than the cross-sectional size of the third coupling hole portion 113. A piston body 320 of the piston unit 300 is inserted into the fourth coupling hole portion 114. A sealing member s is provided between the piston body 320 and the fourth coupling hole portion 114. Oil supplied to the pump housing unit 400 is prevented from leaking toward the motor unit 200 by the sealing member s.

As described above, the piston unit 300, the motor position sensing unit 500, and the pump housing unit 400 are sequentially coupled to the coupling hole 110 of the hydraulic block 100. The coupling process will be described in more detail later.

The motor unit 200 generates a driving force by an electrical signal. Specifically, a motor (not shown) is operated by the electrical signal output from the electronic control unit 50 to generate a rotation driving force.

Although not specifically shown in the drawings, the motor unit 200 includes a motor housing (not shown) connected to the piston unit 300. A protrusion (not shown) is formed on the motor housing (not shown), and the motor housing (not shown) and the piston unit 300 are connected by the protrusion (not shown).

Since the motor housing (not shown) and the piston unit 300 are connected by the protrusion (not shown), a rotational motion of the motor unit 200 is converted into a linear motion of the piston unit 300. A groove portion (not shown) through which the protrusion (not shown) can reciprocate along a longitudinal direction of the piston unit 300 is formed in the piston unit 300.

That is, when the motor unit 200 rotates, the piston unit 300 does not rotate, but the protrusion (not shown) moves along the groove portion (not shown) due to the coupling between the protrusion (not shown) and the groove part (not shown), so that the piston unit 300 can move forward and backward (linear motion).

One side of the piston unit 300 is inserted into and coupled to the hydraulic block 100, and moves forward and backward by the rotational driving force transmitted from the motor unit 200.

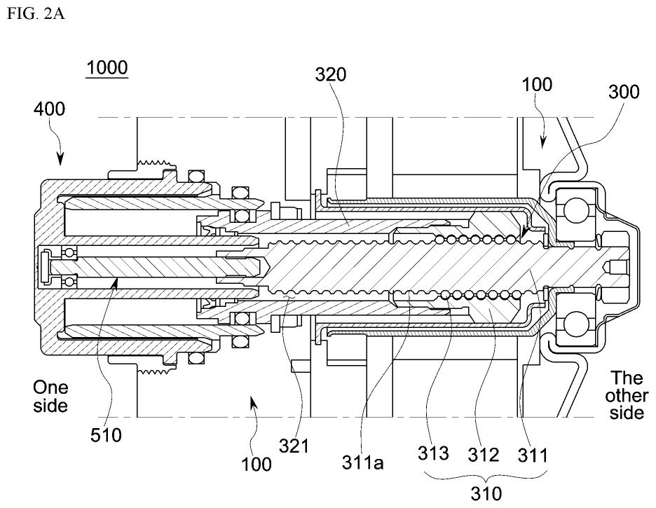

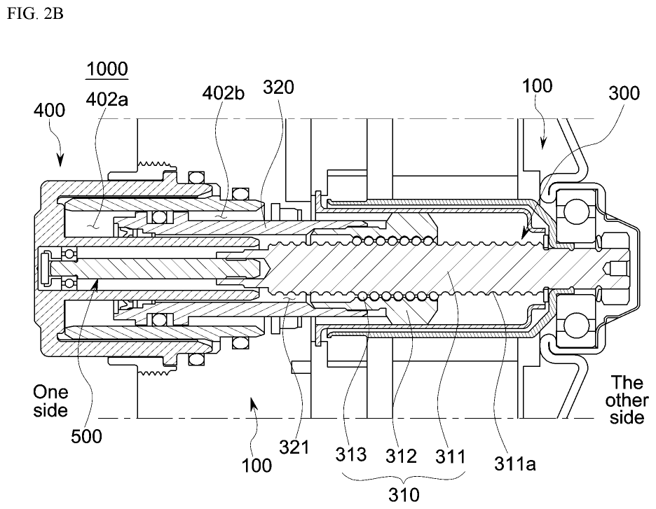

The piston unit 300 includes a ball screw member 310 and the piston body 320. The ball screw member 310 converts the rotational driving force of the motor unit 200 into a linear driving force which causes the piston body 320 to move forward and backward. The ball screw member 310 includes a ball screw 311, a ball nut 312 and balls 313. Referring to FIGS. 2A and 2B, the ball nut 312 is coupled to the other side of the ball screw 311. The balls 313 are provided between the ball screw 311 and the ball nut 312.

When the motor unit 200 provides rotational driving force, the ball screw 311 is rotated. The balls 313 are provided between the ball screw 311 and the ball nut 312, and a spiral groove 311a is formed on an outer circumferential surface of the ball screw 311, so that the ball screw 311 moves forward or backward since the balls 313 continue to rotate in the spiral groove 311a.

The other side of the ball screw member 310 to which the ball nut 312 is coupled is inserted into the motor unit 200.

The other side of the piston body 320 is coupled to the ball screw member 310 and one side thereof is inserted into the pump housing unit 400. The piston body 320 has a piston hollow 322 formed therein along the longitudinal direction.

Specifically, when the piston body 320 is coupled to the ball screw member 310, the ball screw 311 is inserted into the piston hollow 322, the ball nut 312 is combined with the piston body 320 in shape. That is, an outer circumferential surface of the ball nut 312 and an inner circumferential surface of the piston hollow 322 are in close contact.

The piston body 320 moves forward and backward in conjunction with the ball screw member 310. As will be described in more detail later, oil is stored inside the pump housing unit 400, so that the piston unit 300 pressurizes the oil while moving forward to generate hydraulic pressure.

The pump housing unit 400 is coupled to the hydraulic block 100. Specifically, the pump housing unit 400 is inserted into and coupled to the first coupling hole portion 111, the second coupling hole portion 112, and the third coupling hole portion 113.

The pump housing unit 400 receives oil supplied from the reservoir 10 through the hydraulic block 100. One side of the piston unit 300 is coupled to the inside of the pump housing unit 400.

Since oil is stored inside the pump housing unit 400, the piston unit 300 pressurizes the stored oil while moving forward and backward to generate hydraulic pressure.

The pump housing unit 400 includes the housing body 410, the sleeve 420, and the housing fixing member 430. The housing body 410 is coupled so that the other side thereof is inserted into the hydraulic block 100 and one side thereof protrudes from the hydraulic block 100.

The housing body 410 includes a first wall 411, a first side wall 412 extending in a direction intersecting the first wall 411, and a partition wall 414. The housing body 410 has an open surface opposite to the first wall 411. In the present embodiment, the housing body 410 is formed in a cylindrical shape, but is not limited thereto.

The housing body 410 includes a slot 412a. The slot 412a is formed on the first side wall 412. Specifically, the slot 412a is depressed in an inner surface of the first side wall 412 by a set depth, and is formed to have the same length as that of the first side surface 412.

The slot 412a includes a plurality of slots spaced apart by a set angle along the circumferential direction of the housing body 410. In the present embodiment, although there is illustrated and described an example in which four slots 412a are formed along the circumferential direction of the first side surface 412, the present disclosure is not limited thereto, and more slots or less slots may be formed. The slot 412a serves as an inlet flow path through which the oil flows when the housing body 410 and the sleeve 420 are coupled. This will be described in detail later.

The partition wall 414 extends from an inner surface of the first wall 411 in a direction parallel to the first side wall 412. The partition wall 414 is spaced apart from the first side wall 412 by a set distance in a radial direction. The partition wall 414 has a partition wall hollow 414a formed therein along the longitudinal direction.

The ball screw 311 and the motor position sensor unit 500 are inserted into the partition wall hollow 414a.

A length of the partition wall 414 is longer than that of the first side wall 412 so that the partition wall 414 protrudes beyond the open side of the housing body 410.

The housing body 410 is inserted into the second coupling hole portion 112. An outer surface of the first side wall 412 is in close contact with an inner circumferential surface of the second coupling hole portion 112. A first support protrusion 415 protrudes from the outer circumferential surface of the first side wall 412 at a position spaced apart from the open surface by a set distance along the longitudinal direction of the first side wall 412. The first support protrusion 415 extends along the circumferential direction of the first side wall 412.

When the housing body 410 is inserted into the second coupling hole portion 112, the first support protrusion 415 is caught by the stepped portion between the first coupling hole portion 111 and the second coupling hole portion 112.

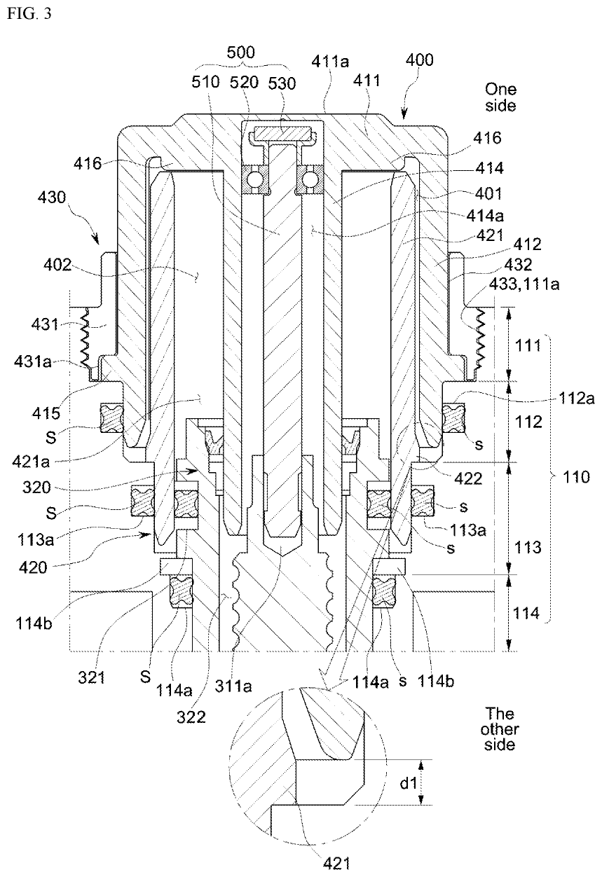

Referring to FIG. 3, the other side of the first side wall 412 is spaced apart from the inner surface of the second coupling hole portion 112 by a set distance dl. The second coupling hole portion 112 communicates with the flow path formed inside the hydraulic block 110 so that the oil supplied from the reservoir 10 flows in the second coupling hole portion 112. When the first side wall 412 is inserted in close contact with the inner surface of the second coupling hole portion 112, a flow path through which oil is introduced may be blocked.

Accordingly, the first side wall 412 is spaced apart from the inner surface of the second coupling hole portion 112 by the set distance dl so that oil can smoothly flow into the housing body 410. The first support protrusion 415 keeps the first side wall 412 and the inner surface of the second coupling hole portion 112 separated by the set distance.

The second coupling hole portion 112 has a sealing groove 112a depressed by a set depth in the inner circumferential surface. The sealing groove 112a extends along the circumferential direction of the second coupling hole portion 112, and a sealing member s is inserted therein.

The sealing member s inserted in the sealing groove 112a prevents oil to flow into the housing body 410 from leaking between the outer circumferential surface of the first side wall 412 and the inner circumferential surface of the second coupling hole portion 112.

A position fixing protrusion 411a is formed on an outer surface of the first wall 411 of the housing body 410. When the hydraulic pressure supply device 1000 is installed in a vehicle body, the position fixing protrusion 411a is formed to help accurately fix the position of the hydraulic pressure supply device 1000. Although not shown in the drawings, a position fixing groove (not shown) is formed in the vehicle body, the position fixing protrusion 411a is inserted into and coupled to the position fixing groove (not shown).

The sleeve 420 is inserted into the housing body 410. The sleeve 420 includes a second side wall 421 in which a sleeve hollow 421a is formed along the longitudinal direction. When the sleeve 420 is inserted into the housing body 410, an outer circumferential surface of the sleeve 420 and the inner circumferential surface of the first side wall 412 come into close contact, but an inflow passage 401 through which the oil supplied from the reservoir 10 flows is formed by the slot 412a.

When the sleeve 420 is inserted into the housing body 410, an inner circumferential surface of the sleeve 420 and an outer circumferential surface of the partition wall 414 are spaced apart by a set distance along the radial direction. The space formed between the sleeve 420 and the partition wall 414 becomes an oil storage space 402.

Oil flows into the oil storage space 402 through the inflow passage 401.

A sleeve contact protrusion 416 is formed on the inner surface of the first wall 411. The sleeve contact protrusion 416 contacts one side of the sleeve 420 when the sleeve 420 is inserted into the housing body 410. By the contact of one side of the sleeve 420 and the sleeve contact protrusion 416, perpendicularity between the sleeve 420 and the housing body 410 can be maintained.

The sleeve contact protrusion 416 includes a plurality of sleeve contact protrusions spaced apart by a set angle along the circumferential direction of the first wall 411. Specifically, one sleeve contact protrusion 416 is formed to be positioned between the neighboring slots 412a.

One side of the sleeve 420 is in contact with the sleeve contact protrusion 416, so that one side of the sleeve 420 and the inner surface of the first wall 411 are spaced apart by a height of the sleeve contact protrusion 416. Accordingly, the oil flowing along the inflow passage 401 flows into the oil storage space 402 through a space formed between the first wall 411 and the sleeve 420.

When the sleeve 420 is inserted into the housing body 410, the other side of the sleeve 420 protrudes beyond the other side of the first side wall 412 by a set length. When the pump housing unit 400 is inserted into the hydraulic block 100, the sleeve 420 is inserted into the third coupling hole portion 113. An outer circumferential surface of the protruding portion of the sleeve 420 is in close contact with an inner circumferential surface of the third coupling hole portion 113.

The sleeve 420 has a second locking protrusion 422 protruding from the outer circumferential surface thereof at a position spaced apart from the other side thereof by a set distance. The second locking protrusion 422 extends along the circumferential direction of the sleeve 420. The second locking protrusion 422 is caught by the stepped portion where the third coupling hole portion 113 and the second coupling hole portion 112 are connected.

The third coupling hole portion 113 communicates with a flow path connected to a backward chamber (not shown) of the reservoir 10. When the sleeve 420 is inserted into the third coupling hole portion 113, the other side of the sleeve 420 and the inner surface of the third coupling hole portion 113 are not brought into close contact with each other by the second locking protrusion 422.

The third coupling hole portion 113 has the sealing member groove 113a concavely formed on the inner circumferential surface thereof. The sealing member groove 113a extends along the circumferential direction of the third coupling hole portion 113, and the sealing member s is inserted therein. When oil flows into the flow path connected to the backward chamber (not shown), oil leakage between the sleeve 20 and the third coupling hole portion 113 is prevented by the sealing member s inserted into the sealing member groove 113a.

Meanwhile, the piston body 320 is inserted between the sleeve 420 and the partition wall 414. As described above, when oil is filled in the oil storage space 402 between the sleeve 420 and the partition wall 414 and the piston unit 300 operates, the piston body 320 moves forward. In this case, hydraulic pressure is formed as the oil filled in the oil storage space 402 is pressurized by the piston body 320.

The piston body 320 has a seal portion 321 depressed by a set depth on the outer circumferential surface at a position spaced apart from one side thereof by a set distance. The seal portion 321 extends along the circumferential direction of the outer circumferential surface of the piston body 320. A sealing member s is provided in the seal portion 321.

The oil storage space 402 is partitioned into a first oil storage space 402a and a second oil storage space 402b by the seal portion 321 of the piston body 320 and the sealing member s.

The first oil storage space 402a is connected to a forward chamber (not shown) of the reservoir 10, and the second oil storage space 402b is connected to the backward chamber (not shown) of the reservoir 10.

The oil stored in the first oil storage space 402a does not leak into the second oil storage space 402b by the sealing member s provided in the sealing groove 311a, and the oil stored in the second oil storage space 402b does not leak into the first oil storage space 402a by the sealing member s provided in the sealing groove 311a.

A fourth sealing groove 114a is formed in the fourth coupling hole portion 114 into which the piston body 320 is inserted. A sealing member s is provided in the fourth sealing groove 114a. The sealing member s seals between the piston body 320 and the fourth coupling hole portion 114. The oil stored in the second oil storage space 402b does not flow into the ball screw unit 320 or the motor unit 200 by the sealing member s provided in the fourth sealing groove 114a.

The housing fixing member 430 fixes the housing body 410 inserted into the hydraulic block 100. The housing fixing member 430 includes a fixed body 431 having a through-hole 432 extending along the longitudinal direction at the center thereof. The housing body 410 passes through the through-hole 432 and is coupled to the fixed body 431.

The fixed body 431 has a second fastening thread 433 formed on the outer circumference thereof, the second fastening thread 433 having a set length from the other side toward one side of the fixed body 431. The housing fixing member 430 is fixed by a screw fastening method through the second fastening screw thread 433. Accordingly, a first fastening thread 111a that can be screwed with the second fastening thread 433 is formed in the hydraulic block 100. Since the housing fixing member 430 is inserted into the first coupling hole portion 111, the first fastening thread 111a is formed in the first coupling hole portion 111.

A protrusion fixing groove 431a is formed on an inner circumferential surface of the fixed body 431. The protrusion fixing groove 431a is formed in a shape corresponding to the first support protrusion 415. When the fixed body 431 is inserted into and coupled to the first coupling hole portion 111, the protrusion fixing groove 431a is matched with the first support protrusion 415. As the protrusion fixing groove 431a is matched with the first support protrusion 415, one surface of the sleeve 420 and the sleeve contact protrusion 416 are brought into close contact to maintain perpendicularity, and the pump housing unit 400 is fixed.

The motor position sensing unit 500 has one side coupled to the piston unit 300 and the other side inserted into the pump housing unit 400. In order to control the position of the piston unit 300, rotation of the motor (not shown) in the motor unit 200 needs to be controlled. The motor position sensing unit 500 is a component for sensing rotation of the motor (not shown) provided in the motor unit 200.

The motor position sensing unit 500 includes a sensor rod 510, a bearing 520, and a magnet 530. One side of the sensor rod 510 is press-fitted in the other side of the ball screw 311. To this end, a press-in hole 311a depressed by a set depth along the longitudinal direction of the ball screw 311 is formed on the other side of the ball screw 311.

As the sensor rod 510 is press-fitted in the ball screw 311, the sensor rod 510 rotates in conjunction with the ball screw member 310.

The bearing 520 is coupled to the other side of the sensor rod 510. As described above, the motor position sensing unit 500 is inserted into the partition wall 414. If the other side of the sensor rod 510 is in a free end state, shaking may occur when the piston unit 300 moves forward and backward. Accordingly, by coupling the bearing 520 to the other side of the sensor rod 510, the sensor rod 510 is guided by the pump housing unit 400, and shaking of the sensor rod 510 is prevented.

The magnet 530 is provided at the other side end of the sensor rod 510. The motor position sensing unit 500 may detect the rotational position of the motor of the motor unit 200 based on the magnetic flux change due to the rotation of the magnet 530.

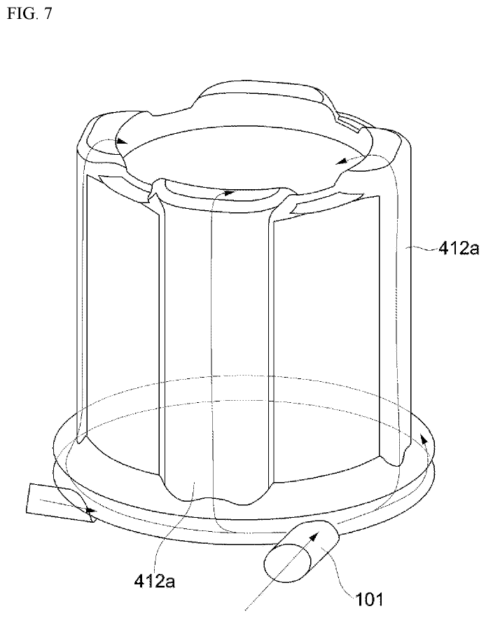

In FIG. 7, the flow of the oil supplied from the reservoir 10 is indicated by arrows. Referring to FIG. 7, oil supplied from the reservoir 10 flows along the flow path 101 of the hydraulic block 100 and flows into the pump housing unit 400. Oil flows between the housing body 410 and the sleeve 420, flows into the slot 412a, and flows into the oil storage space 402 from one side of the housing body 410.

Hereinafter, the assembly process of the hydraulic pressure supply device as described above will be described.

First, the hydraulic block 100 and the piston unit 300 are prepared. The piston body 320 of the piston unit 300 is inserted into the fourth coupling hole portion 114. The piston body 320 is inserted from the first coupling hole portion 111 toward the fourth coupling hole portion 114.

The fourth coupling hole portion 114 is provided with a position fixing ring 114b. As the piston body 320 is caught by the position fixing ring 114b, the insertion position of the piston body 320 is determined.

When the piston body 320 is inserted into the fourth coupling hole portion 114, the ball screw member 310 is inserted into the piston body 320.

Next, the motor unit 200 is coupled in a direction from the other side of the piston unit 300 to one side in such a way that the piston unit 300 is inserted into the motor unit 200. In addition, the ball screw member 310 is operated by the power provided by the motor unit 200 without being separated from the piston body 320.

After the coupling of the motor unit 200 is fixed, the motor position sensing unit 500 is assembled. The other side of the motor position sensing unit 500 is inserted into one side of the ball screw 311 and coupled thereto.

Next, the pump housing unit 400 is coupled. First, the sleeve 420 of the pump housing unit 400 is coupled. The sleeve 420 is inserted into and coupled to the third coupling hole portion 113. In this case, the sealing member s is provided between the sleeve 420 and the piston body 310, and in the third coupling hole portion 113.

After the sleeve 420 is coupled, the housing body 410 is coupled. The housing body 410 is inserted into the second coupling hole portion 112, and the motor position sensing unit 500 is inserted into the partition wall 414.

The first support protrusion 415 formed on the outer surface of the housing body 410 is caught by the stepped portion between the first coupling hole portion 111 and the second coupling hole portion 112, and the position of the housing body 410 is fixed

Finally, the housing fixing member 430 is inserted into the first coupling hole portion 111, and the assembly of the hydraulic pressure supply device 1000 is completed as the housing fixing member 430 and the first coupling hole portion 111 are fastened together.

According to the present disclosure, the pump housing unit is composed of the housing body and the sleeve, so that the configuration and structure of the pump housing unit can be simplified. In particular, by forming the slot depressed from the inner surface of the housing body, the flow path through which fluid flows and the storage space in which the fluid is stored can be formed simply by inserting the sleeve into the housing body.

Since the housing main body includes the hollow partition wall, the motor position sensor unit can be provided by inserting it into the hollow partition wall, so that the size of the hydraulic pressure supply device can be made compact.

Although the embodiments of the present disclosure have been described with reference to the accompanying drawings, those skilled in the art to which the present disclosure pertains may understand that the present disclosure can be implemented in other specific forms without changing the technical ideas or essential features of the present disclosure.

Therefore, the embodiments described above should be understood as illustrative in all respects and not limiting, and the scope of the present disclosure is defined by the following claims, and meaning and scope of the claims and any changes or modifications derived from the equivalent should be construed as included in the scope of the present disclosure.

(Description of Reference Numerals)

| | |
|---|---|
| 10: reservoir | 410: housing body |
| 20: brake pedal | 412a: slot |
| 30: master cylinder | 414: partition wall |
| 40: pedal simulator | 416: sleeve contact protrusion |
| 50: electronic control unit | 420: sleeve |
| 60: hydraulic circuit unit | 430: housing fixing member |
| 70: wheel cylinder | 500: motor position sensing unit |
| 1000: hydraulic pressure supply | 510: sensor rod |
| device | 520: bearing |
| 100: hydraulic block | 530: magnet |
| 110: coupling hole | |
| 111: first coupling hole portion | |
| 112: second coupling hole portion | |
| 113: third coupling hole portion | |
| 114: fourth coupling hole portion | |
| 200: motor unit | |
| 300: piston unit | |
| 310: ball screw member | |
| 320: piston body | |
| 400: pump housing unit | |
| 401: inflow passage | |
| 402: oil storage space | |
| 402a: first oil storage space | |
| 402b: second oil storage space | |

What is claimed is:

1. A hydraulic pressure supply device comprising:
a hydraulic block having therein a flow path through which oil supplied from a reservoir flows;
a motor unit that generates rotational driving force by an electrical signal;
a piston unit coupled to the hydraulic block and moving forward and backward by the rotational driving force;
a pump housing unit which is coupled to the hydraulic block to be opposite to the piston unit and in which oil introduced from the hydraulic block is stored so that the piston unit moving forward and backward forms hydraulic pressure; and
a motor position sensor unit that senses rotation of the motor unit, one side and the other side of the motor position sensor unit being respectively coupled to the pump housing unit and the piston unit,
wherein the pump housing unit includes:
a housing body having an open side and an inner space formed therein; and
a sleeve inserted into the inner space.

2. The hydraulic pressure supply device of claim 1, wherein the housing body includes:
a first wall;
a first side wall extending in a direction intersecting the first wall, a side thereof opposite to the first wall being opened; and
a partition wall spaced apart from the first side wall by a set distance in a radial direction and extending parallel to the first side wall at an inner side of the first side wall to form a hollow therein.

3. The hydraulic pressure supply device of claim 2, wherein the housing body includes a slot depressed by a set depth in an inner surface of the first side wall and formed to extend from the open side toward the first wall.

4. The hydraulic pressure supply device of claim 3, wherein the slot includes a plurality of slots spaced apart by a set angle along a circumferential direction of the first side wall.

5. The hydraulic pressure supply device of claim 4, wherein the housing body has a sleeve contact protrusion that is formed on an inner surface of the first wall to be in close contact with any one side of the sleeve inserted into the housing body.

6. The hydraulic pressure supply device of claim 5, wherein one or more sleeve contact protrusions are formed between the neighboring slots.

7. The hydraulic pressure supply device of claim 2, wherein the partition wall is formed so that one end thereof protrudes beyond the open side of the housing body.

8. The hydraulic pressure supply device of claim 2, wherein the housing body further includes a first support protrusion protruding from an outer surface of the first side wall and extending along a circumferential direction thereof.

9. The hydraulic pressure supply device of claim 5, wherein the sleeve has a sleeve hollow formed to extend along a longitudinal direction thereof, and
when the sleeve is inserted into the housing body, one end of the sleeve that is not inserted into the housing body protrudes beyond the open side of the housing body.

10. The hydraulic pressure supply device of claim 9, wherein when the sleeve is inserted into the housing body, the other end of the sleeve that is inserted into the housing body comes in close contact with the sleeve contact protrusion so as to maintain perpendicularity between the sleeve and the first wall.

11. The hydraulic pressure supply device of claim 10, wherein when the sleeve is inserted into the housing body, the slot is formed as an inflow passage through which the oil flows, and a space formed between an inner circumferential surface of the sleeve and an outer circumferential surface of the partition wall becomes an oil storage space for storing the oil so that the piston unit moving forward and backward generates hydraulic pressure.

12. The hydraulic pressure supply device of claim 10, wherein the pump housing unit further includes a housing fixing member through which the housing body passes and which is fastened to the hydraulic block to fix the housing body.

13. The hydraulic pressure supply device of claim 12, wherein the housing fixing member includes a fixed body having a through-hole formed along a longitudinal direction thereof so that the housing body passes therethrough.

14. The hydraulic pressure supply device of claim 12, wherein the piston unit includes:
a ball screw member that converts the rotational driving force into a linear driving force; and
a piston body having one side inserted into the pump housing unit, the piston body being coupled to the ball screw member to move forward and backward.

15. An electronic brake system comprising:
a reservoir in which oil is stored;
a master cylinder that provides a pedal feeling to a driver while discharging oil by operation of a brake pedal and; and
a hydraulic pressure supply device that generates hydraulic pressure by operating a hydraulic piston by an electrical signal output in response to displacement of the brake pedal,
wherein the hydraulic pressure supply device includes:
a hydraulic block having therein a flow path through which oil supplied from the reservoir flows;
a motor unit that generates rotational driving force by an electrical signal;
a piston unit coupled to one side of the hydraulic block and moving forward and backward by the rotational driving force;
a pump housing unit which is coupled to the hydraulic block to be opposite to the piston unit and in which oil introduced from the hydraulic block is stored so that the piston unit moving forward and backward forms hydraulic pressure; and
wherein the pump housing unit includes:
a housing body having an open side and an inner space formed therein; and
a sleeve inserted into the inner space.

16. The electronic brake system of claim 15, wherein the housing body includes:
a first wall;
a first side wall extending in a direction intersecting the first wall, a side thereof opposite to the first wall being opened; and
a partition wall spaced apart from the first side wall by a set distance in a radial direction and extending parallel to the first side wall at an inner side of the first side wall to form a hollow therein.

17. The electronic brake system of claim 16, wherein the housing body includes a slot depressed by a set depth in an inner surface of the first side wall and formed to extend from the open side toward the first wall.

18. The electronic brake system of claim 17, wherein the housing body has a sleeve contact protrusion that is formed on an inner surface of the first wall to be in close contact with any one side of the sleeve inserted into the housing body.

19. The electronic brake system of claim 18, wherein the sleeve includes a cylindrical second side wall in which a sleeve hollow extending along a longitudinal direction thereof is formed.

20. The electronic brake system of claim 19, wherein when the sleeve is inserted into the housing body, one end of the sleeve that is inserted into the housing body comes in close contact with the sleeve contact protrusion so as to maintain perpendicularity between the sleeve and the first wall.
